(19) United States
(12) Patent Application Publication
(10) Pub. No.: US 2009/0098510 A1
(43) Pub. Date: Apr. 16, 2009

(54) DENTAL IMPLANT AND PROSTHETIC DEVICE PREPARATION KIT

(76) Inventor: Kai Zhang, St. Paul, MN (US)

Correspondence Address: FITCH EVEN TABIN AND FLANNERY, 120 SOUTH LASALLE STREET, SUITE 1600, CHICAGO, IL, 60603-3406, US

(21) Appl. No.: 11/873,018

(22) Filed: Oct. 16, 2007

(51) Int. Cl. A61C 8/00

(52) U.S. Cl. 433/201.1

(57) ABSTRACT

A preparation kit for preparing dental prosthetic devices in-house at the site of a dental procedure, without requiring an external third-party lab to prepare the final prosthetic device. The kit contains a porous block, a thermoset polymeric resin, and an initiator, where the resin and initiator are both packaged in substantially airtight and substantially opaque packaging. The resin and initiator are combined together to form a resin mixture which is then infiltrated into the pores of the porous block to form an esthetic material. A digital scan of at least a portion of a patient's jaw is used to provide the desired shape of the dental device to a cutting mechanism, which then cuts the filled or un-filled porous block based on the shape provided to it from the digital scan.

### FIELD OF THE INVENTION

The present invention relates to a kit for preparing dental implant and prosthetic devices and, in particular, to an in-house preparation kit that provides for assembly and shaping of the dental implant and prosthetic device.

### BACKGROUND OF THE INVENTION

A dental implant or fixture is surgically implanted into a patient's upper or lower jaw to directly or indirectly anchor and support prosthetic devices, such as an artificial tooth. The implants are usually placed at one or more edentulous sites in a patient's indentation at which the patient's original teeth have been lost or damaged in order to restore the patient's chewing function. In many cases, the implant anchors a dental abutment, which in turn provides an interface between the implant and a prosthesis also called a dental restoration or artificial tooth that has the exterior shape of a tooth. The artificial tooth is typically a porcelain crown fashioned according to known methods.

Currently, the prosthetic devices, which include the implant and the abutment, are provided in standard sizes and are typically implanted before the prosthesis is mounted on it in the patient's mouth. More recent dental prosthetic devices have complex manufacturing processes that use metallic and ceramic materials. These are used to form more durable prosthetic devices and prosthetic devices more esthetically pleasing where the prosthetic device is exposed apically of the outer edge of a tooth-shaped prosthesis and above the gum line for instance. The prosthetic device may also be provided with an esthetically pleasing color when the prosthesis is transparent or translucent such that the color of the prosthetic device affects the color of the prosthesis. Due to the complexity of the materials and processes, the dental practitioner is unable to produce such a high-quality prosthetic device in-house.

The artificial tooth or prosthesis is typically made in at least two separate stages: a scanning/molding stage and a machining stage. In the scanning/molding stage, a mold or a cast of a patient's tooth is made, typically in the dental office, and the mold is then sent out to a third-party or otherwise external lab. In the machining stage, a prosthetic device or analog of an appropriate standard size of the prosthetic device is placed on the mold, and the mold is then used to make a model of the mouth. The dental prosthesis or restoration is mounted on the prosthetic device or analog on the model and shaped, and/or the model is used to cast the restoration into a tooth shape with other mold pieces providing the exterior colonal shape of the tooth. Once the prosthesis is formed, it is then sent back to the dental office. Then, the patient returns to the dental office to have the prosthesis or restoration implanted on a previously implanted prosthetic device. Thus, this method requires that the prosthetic device and prosthesis be made at two different times and with at least two patient office visits with a wait between the office visits to have the artificial tooth molded and implanted.

Furthermore, a risk exists that the prosthesis may be returned to the dental office with incorrect dimensions. If the errors are major, the external lab will need to remake the prosthesis and new molds may need to be made. If the errors are minor, this may require the dental practitioner to finely shape the prosthetic device to get the prosthesis to fit on the prosthetic device or between adjacent teeth in the patient's mouth, which causes even further delay.

Some dental restorations, such as crowns, veneers, inlays, or onlays may be made in-house. In one known example, the dental practitioner can take a digital scan of the patient's mouth and output that scan to a milling machine. The milling machine uses the scan to cut and shape a solid ceramic piece to match a desired tooth shape indicated on the scan. This allows the dental practitioner to complete the procedure of scanning the tooth, cutting the ceramic piece and implanting the resulting restoration all in-house and in the same day, if desired. This method, however, has so far been limited to restorations made of simple materials such as the piece of ceramic. Thus, ways to provide high quality prosthetic devices in-house, in addition to the prosthesis, are desired.

### BRIEF DESCRIPTION OF THE DRAWINGS

FIG. 1 is a schematic block diagram representing a simplified kit in accordance with the present invention;

FIG. 2 is a flow diagram of a process for making a dental prosthetic implant device from a kit in accordance with the present invention; and

FIG. 3 is a flow diagram of an alternative process for making a dental prosthetic implant device from a kit in accordance with the present invention.

### DETAILED DESCRIPTION

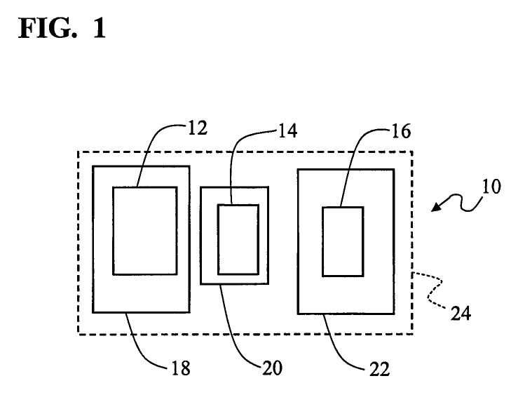

Referring to FIG. 1, a preparation kit 10 has a porous block 12, a thermoset polymeric resin 14, and an initiator 16 to be used in-house to create a final prosthetic device that will be cut and shaped to support a restoration or to integrally provide an artificial tooth. The prosthetic device created from the kit 10 comprises a highly durable and esthetically pleasing (i.e., tooth colored in appearance) dental device. The term “in-house” herein means that the dental device can be prepared in one location at the site of a dental procedure, such as a dental office or a dental practitioner's place of business, and does not require molds being sent to an external location or lab to be used by a third-party. Dental practitioner hereinafter will include a dentist, a dental technician, dental surgeon, a dental hygienist, or anyone employed in a dental office.

The kit 10 may have a container or package 18 such as a bag for holding the porous block 12. The resin 14 may be held in its own container 20, such as a substantially air tight and substantially opaque bottle, box, or bag; preferably a bottle is used when the resin is in liquid form. Air tight herein means sufficiently sealed to substantially restrict the flow of oxygen into the relevant container. In one form, the initiator 16 is also in its own substantially air tight and substantially dark colored or opaque container 22 to keep it substantially separated from the resin 14 to limit any unintentional reaction with the resin. The kit 10 may also have a container 24 such as a box, bag, or bottle to hold all three elements of the kit: block 12, resin 14, and initiator 16. It will be appreciated, however, that many forms for the packaging of the kit 10 are possible as long as the packaging separates the three elements of the kit 10. This includes having one container 24, whether air tight and/or opaque or not, for holding one smaller container for each of the three elements. It will also be understood that one package may be opaque while an inner or outer package may be sealed. At least one of the packages may be air tight and/or opaque, or all of them may be.

Generally, to make the prosthetic device, the dental practitioner removes the porous block 12 from the kit 10 and mixes together the resin 14 and the initiator 16 in amounts indicated on instructions provided on or in the kit 10. Once the resin 14 and initiator 16 are mixed together, a resin mixture is formed which can then be placed on the porous block 12 such that the resin mixture infiltrates pores of the porous block. The resin mixture on the porous block 12 then cures in situ by polymerization of the resin mixture via light or heat that penetrates the porous block. The porous block 12 may then be cut to form the final prosthetic dental device with a size particularly customized to fit on a patient's jaw and between adjacent teeth. The prosthetic device made from the kit 10 may include an implant, an abutment, a one-piece dental implant or other type of dental fixture.

The porous block 12 is made of at least one of the following: a porous ceramic, a porous metal, or a porous polymer, or a porous composite material. In one aspect, a porous ceramic block is preferred. The porous block can have a porosity range of about 30% to about 90% and a pore size distribution of about 10 to about 1000 microns.

If a porous ceramic material is used, it may comprise at least one element selected from the group consisting of: alumina, zirconia, hydroxyapatite, or layered ceramic fabrics such as 3M Nextel 610 alumina fabrics, for example, available from 3M Company, St. Paul, Minn.

A porous metal may comprise at least one element selected from the group consisting of: titanium, tantalum, CoCrMo, stainless steel, and zirconium. For example, a porous metal portion may comprise a porous tantalum portion which is a highly porous biomaterial useful as a bone substitute and/or cell and tissue receptive material. An example of such a material is produced using Trabecular Metal™ technology generally available from Zimmer, Inc., of Warsaw, Ind. Trabecular Metal™ is a trademark of Zimmer Technology, Inc. Such a material may be formed from a reticulated vitreous carbon foam substrate which is infiltrated and coated with a biocompatible metal, such as tantalum, etc., by a chemical vapor deposition (“CVD”) process in the manner disclosed in detail in U.S. Pat. No. 5,282,861, the disclosure of which is fully incorporated herein by reference.

A porous polymer may comprise at least one element selected from the group consisting of: poly aryl ether ketone (PAEK), polyether ether ketone (PEEK), polyether ether ketone (PEKK), polymethylmethacrylate (PMMA), and ultra high molecular weight polyethylene (UHMWPE).

A porous composite material may comprise at least one the following combinations: polymer and ceramic fibers, polymer and metallic fibers, metal and polymer coatings, metal and ceramic coatings, ceramic and polymer coatings, and ceramic and metal coatings. An example of a polymer and metallic fiber composite material is disclosed in detail in commonly owned U.S. patent application Ser. Nos. 11/420,024 and 11/622,171, which are fully incorporated herein by reference. By one approach, the porous block 12 that is provided in the kit is made of the composite polymer and metallic fibers where the polymer provides the bulk of the matrix forming the porous block 12 and the metallic fiber is a reinforcing material. The composite material may also be pre-mixed with a colorant to form an esthetically pleasing color. A further resin mixture is then placed on and in the composite material. In a different approach, the porous block 12 is made of the polymer matrix material and the resin mixture that is added at the dental office includes the reinforcing material and the colorant. In either of these cases, the matrix material may be a polyaryl ether ketone (PAEK) such as polyether Ketone (PEKK), polyether ether ketone (PEEK), polyether ketone ether ketone (PEKEKK), polymethylmethacrylate (PMMA), polyetherimide, polysulfone, and polyphenylsulfone. The polymers can also be a thermoset material including, without limitation, bisphanol glycidyl methacrylate (Bis-GMA), urethane dimethacrylate (UDMA), methylmethacrylate (MMA), triethylene glycol dimethacrylate (TEGDMA), a combination of thermoset plastics, or a combination of thermoset and thermoplastics. Additionally, they can be comprised of, without limitation, a large class of monomers, oligomers and polymers, such as acrylics, styrenics and other vinyls, epoxies, urethanes, polyesters, polycarbonates, polyamides, radiopaque polymers and biomaterials.

The reinforcing material may comprise, to name a few possible examples, at least one selected from the group comprising: carbon, Al₂O₃, ZrO₂, Y₂O₃, Y₂O₃-stabilized ZrO₂, MgO-stabilized ZrO₂, E-glass, S-glass, bioactive glasses, bioactive glass ceramics, calcium phosphate, hydroxyapatite, TiO₂, Ti, Ti₆Al₄V, stainless steel, polyaryl ether ketones (PAEK) such as polyethyl ethyl ketone (PEEK), polyethyl ketone (PEKK), and an aramid. The geometry of the reinforcing material may include fibers, particulates, variable diameter fibers and fibers fused with particulates on the fiber surfaces. The colorant may be titanium dioxide as one example.

In one form, the composite material, whether constituting the complete prosthetic device or just the porous block 12, may comprise about 55% by weight of the composite material of PEKK as the matrix material, about 35% by weight of the composite material of E-glass fibers as the reinforcing material, and about 10% by weight of the composite material of titanium dioxide particles as the colorant. In another example, the composite material may comprise about 53% by weight of the composite material of PEKK, as the matrix material, about 35% by weight of the composite material of E-glass fibers as the reinforcing material, and about 12% by weight of the composite material of titanium dioxide particles as the colorant.

The thermoset polymeric resin 14 may comprise a light-curable, thermoset acrylic resin, such as Bisphenol-A-glycidyldimethacrylate (BisGMA), triethylene glycol dimethacrylate (TEGDMA), or urethane dimethacrylate (UDMA). For example, the resins 14 may have a weight ratio of BisGMA to TEGDMA from 9:1 to 1:9. The thermoset resins 14 may further be stabilized by stabilizers. For example, stabilizers that may be used for BisGMA and TEGDMA may comprise Topanol O® i.e., in an amount of about 200 ppm, and hydroquinone methyl ether (HQME), i.e., in an amount of 100 ppm, respectively.

Other thermoset polymeric resin materials that may be used can include, without limitation, one or more of the following elements: acenaphthylene, 3-aminopropyltrimethoxysilane, diglycidyletherbisphenol, 3-glycidylpropyltrimethoxysilane, tetrabromobisphenol-A-dimethacrylate, polyactide, polyglycolide, 1,6-hexamethylene dimethacrylate, 1,10-decamethylene dimethacrylate, benzyl methacrylate, butanediol monoacrylate, 1,3-butanediol diacrylate(1,3-butylene glycol diacrylate), 1,3-butylene glycol dimethacrylate), 1,4-butanediol diacrylate, 1,4-butanediol dimethacrylate, n-butyl acrylate, n-butyl methacrylate, t-butyl acrylate, t-butyl methacrylate, n-butyl vinyl ether, tbutylaminoethyl methacrylate, 1,3-butylene glycol diacrylate, cyclohexyl acrylate, cyclohexyl methacrylate, n-decyl acrylate, n-decyl methacrylate, diethylene glycol diacrylate, diethylene glycol dimethacrylate, dipentaerythritol monohydroxypentaacrylate, 2-ethyoxyethoxyethyl acrylate, 2-ethoxyethyl methacrylate, ethoxylated bisphenol A diacrylate, ethoxylated bisphenol A dimethacrylate, ethoxylated trimethylolpropane triacrylate, ethyl methacrylate, ethylene glycol dimethacrylate, 2-ethylhexyl acrylate, 2-ethylhexyl methacrylate, furfuryl methacrylate, glyceryl propoxy triacrylate, 1,6hexanediol diacrylate, 1,6hexanediol dimethacrylate, n-hexyl acrylate, n-hexyl methacrylate, 4-hydroxybutyl-acrylate, butanediol monoacrylate, 2-hydroxyethyl acrylate, hydroxyethyl methacrylate, hydroxypropyl acrylate, hydroxypropyl methacrylate, isobomyl acrylate, isobomyl methacrylate, isobutyl acrylate, isobutyl methacrylate, isobutyl vinyl ether, isodecyl acrylate, isodecyl methacrylate, isooctyl acrylate, isopropyl methacrylate, lauryl acrylate, lauryl methacrylate, maleic anhydride, methacrylic anhydride, 2-methoxyethyl acrylate, methyl methacrylate, neopentyl acrylate, neopentyl methacrylate, neopentyl glycol diacrylate, neopentyl glycol dimethacrylate, n-octadecyl acrylate, stearyl acrylate, n-octadecyl methacrylate, stearyl methacrylate, n-octyl acrylate, pentaerythritol tetraacrylate, pentaerythritol triacrylate, 2-phenoxyethyl acrylate, 2-phenoxyethyl methacrylate, 2-phenylethyl methacrylate, phenyl methacrylate, polybutadiene diacrylate oligomer, polyethylene glycol 200 diacrylate, polyethylene glycol 400 diacrylate, polyethylene glycol 200 dimethacrylate, polyethylene glycol 400 dimethacrylate, polyethylene glycol 600 dimethacrylate, polypropylene glycol monomethacrylate, propoxylated neopentyl glycol diacrylate, stearyl acrylate, stearyl methacrylate, 2-sulfoethyl methacrylate, tetraethylene glycol diacrylate, tetraethylene glycol dimethacrylate, tetrahydrofurfuryl acrylate, tetrahydrofurfuryl methacrylate, n-tridecyl methacrylate, triethylene glycol diacrylate, triethylene glycol dimethacrylate, trimethylolpropane triacrylate, trimethylolpropane trimethacrylate, 3-methacryloxypropyltrimethoxysilane, trimethylsilylmethacrylate, (trimethylsilymethyl)methacrylate, tripropylene glycol diacrylate, tris(2-hydroxyethyl)isoyanurate triacrylate, vinyl acetate, vinyl caprolactam, n-vinyl-2-pyrrolidone, zinc diacrylate and zinc dimethacrylate.

The initiator 16 is mixed with the resin 14 which causes polymerization of the resin mixture when exposed to light or heat. The initiator 16 can be present in amounts from about 0.2 wt % to about 5 wt % of the resin. Initiators 16 may be in a powder form and can comprise initiators for thermal curing such as benzoyl peroxide or dicumyl peroxide, in amounts of about 0.5 wt % to about 5 wt % relative to the resin, and more preferably in an amount of about 1 wt %. Initiators 16 that are used with light curing may comprise ethyl 4-dimethylaminobenzoate (4E) or camphorquinone (CQ), such as is available from Aldrich, in Milwaukee, Wis. Typical amounts used of the light curing initiators may be about 0.8 wt % of 4E and about 0.2 wt % of CQ, relative to the resin.

In order to make the prosthetic device, the dental practitioner first obtains a replica of the patient's jaw, gingival tissue, tooth to be replaced, and the adjacent teeth in order to determine the proper size and shape of prosthetic device that is needed. This can be done by the dental practitioner in any format that would allow for a relatively immediate result, so that the porous block 12 can thereafter be shaped to fit on the jaw, between adjacent teeth, and support a restoration. It may alternatively be shaped further if the prosthetic device is integrally providing the coronal shape of the tooth.

A preferred method is to obtain a digital scan of the patient's tooth and/or mouth which can be obtained utilizing a digital dental system (DDS), for example, which allows the dental practitioner to take a digital scan of the patient's mouth to determine the size and shape of the patient's dental anatomy. The DDS results in a 3-dimensional structure that can be converted via computer software to be sent as an input to a cutting mechanism. The DDS can convert an analog image of the anatomy to a digital image. For example, a detector is used to convert the transmitted light of a conventional radiograph or the remnant x-ray beam into an electronic signal. The electronic signal is then converted from an analog form to a digital form. Using special software, the digital image from the digital scan is used to generate a design (CAD) which can then be sent to the cutting mechanism and used as the shape to which the porous block 12 is cut.

The cutting mechanism may comprise a rapid prototyping machine or similar machines that cuts the porous block 12 to the desired shape as obtained from the digital scan. Rapid prototyping takes virtual designs from computer aided design (CAD) or animation modeling software, transforms them into thin horizontal cross sections, still virtual, and then creates each cross section in physical space, one after the other until the model is finished

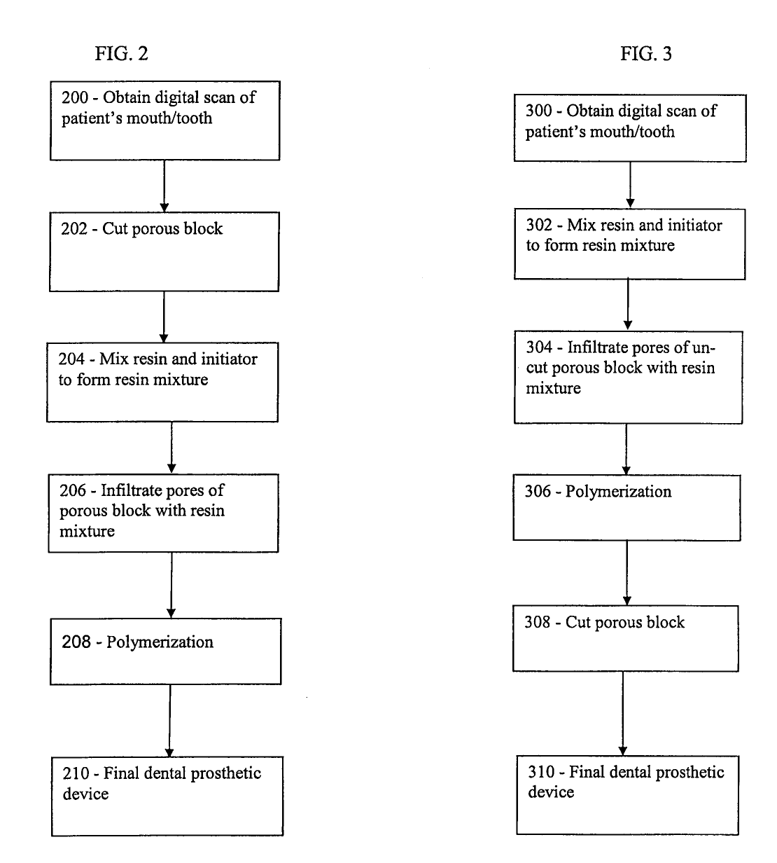

Referring to FIG. 2, one possible method of making the prosthetic dental device includes first obtaining (step 200) a digital scan of the patient's mouth, utilizing for example a DDS. The scan is then converted to a CAD format, or other comparable format, and is sent to a cutting mechanism such as the rapid prototyping machine. The rapid prototyping machine can then cut the porous block 12 to the desired shape based upon the digital scan obtained (step 202). After the porous block 12 is cut to the desired shape, the resin 14 and the initiator 16 are combined and mixed together to form the resin mixture (step 204). If the resin 14 or initiator 16 is light-curable, then the mixing should be performed in relatively dark conditions.

The resin mixture is added (step 206) to the shaped porous block 12 and the mixture infiltrates the pores of the block. After the pores have been infiltrated with the resin mixture, the infiltrated block is polymerized (step 208), via light or heat depending upon the type of resin used, to cure the resin mixture and prepare the esthetic composite device for implanting into a patient's mouth. A light curing process, such as a Triad 2000 from Dentsply International Inc., in York, Pa., can be used if light-curing is necessary. When heat curing is needed, a low-temperature furnace may be used. Optionally, fine machining may be performed to finalize the shape of the infiltrated block if only a rough cut out was previously made. Once accomplished, the infiltrated block 12 has been transformed into the final prosthetic device to be used by the dental practitioner to implant into the patient's mouth (step 210).

Referring to FIG. 3, alternatively, the porous block 12 may not be cut or shaped until after it is infiltrated by the resin mixture. Thus, by one approach, the digital scan is taken (step 300), and the resin 14 and initiator 16 are then mixed (step 302) to form the resin mixture. It will be appreciated, however, that the patient may be scanned and the digital scan developed for the cutting mechanism before, during or after the resin mixture is formed, the mixture is poured on the un-shaped, un-cut porous block 12 to infiltrate the block's pores (step 304), or the resin mixture is polymerized (step 306), preferably whichever saves the most time for the dental practitioner. Again, if the resin 14 and/or initiator 16 are light-curable, then the mixing needs to be performed in relatively dark conditions.

Once the resin mixture is polymerized on the porous block 12 by exposure to light or heat and cured, the block 12 is disposed for cutting and shaping by the rapid prototyping machine. The previously obtained digital scan is converted to a CAD format, or other comparable format, and is sent to the rapid prototyping machine. The rapid prototyping machine can then cut the infiltrated porous block 12 to the desired shape (step 308) based upon the digital scan obtained. Once the infiltrated block 12 is cut, the final prosthetic device is ready to be implanted into the patient's mouth (310).

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A kit to make a dental prosthetic device, comprising:
a porous block having pores;
a thermoset polymeric resin;
an initiator for combination with the resin to form a resin mixture for being added to the porous block to infiltrate the pores therein; and
at least one substantially air tight and substantially opaque package for covering at least the resin and initiator therein.

2. The kit of claim 1, wherein the porous block has a porosity of 30-90% and a pore size distribution of 10 to 1000 microns.

3. The kit of claim 2, wherein the porous block can comprise at least one of a porous ceramic, metal, polymer, and composite material.

4. The kit of claim 3, wherein the porous ceramic is at least one element selected from the group consisting of alumina, zirconia, hydroxyapatite, and layered ceramic fabrics.

5. The kit of claim 3, wherein the porous metal is at least one element selected from the group consisting of titanium, tantalum, CoCrMo, stainless steel, and zirconium.

6. The kit of claim 3, wherein the porous polymer is at least one element selected from the group consisting of poly aryl ether ketone (PAEK), polyether ether ketone (PEEK), polyether ether ketone (PEKK), polyether ether ketone (PMMA), polyether ketone ether ketone (PEKEKK), polyetherimide, polysulfone, polyphenylsulfone, ultra high molecular weight polyethylene (UHMWPE), bisphanol glycidyl methacrylate (Bis-GMA), urethane dimethacrylate (UDMA), methylmethacrylate (MMA), and triethylene glycol dimethacrylate (TEGDMA).

7. The kit of claim 3, wherein the porous composite material is at least one element selected from the group consisting of polymer and ceramic fibers, polymer and metallic fibers, metal and polymer coatings, metal and ceramic coatings, ceramic and polymer coatings, and ceramic and metal coatings.

8. The kit of claim 1, wherein the thermoset polymeric resin is at least one element selected from the group consisting of Bisphenol-A-glycidyldimethacrylate (BisGMA), triethylene glycol dimethacrylate (TEGDMA), urethane dimethacrylate (UDMA), acenaphthylene, 3-aminopropyltrimethoxysilane, diglycidyletherbisphenol, 3-glycidylpropyltrimethoxysilane, tetrabromobisphenol-A-dimethacrylate, polyactide, polyglycolide, 1,6-hexamethylene dimethacrylate, 1,10-decamethylene dimethacrylate, benzyl methacrylate, butanediol monoacrylate, 1,3-butanediol diacrylate(1,3-butylene glycol diacrylate), 1,3-butylene glycol dimethacrylate), 1,4-butanediol diacrylate, 1,4-butanediol dimethacrylate, n-butyl acrylate, n-butyl methacrylate, t-butyl acrylate, t-butyl methacrylate, n-butyl vinyl ether, tbutylaminoethyl methacrylate, 1,3-butylene glycol diacrylate, cyclohexyl acrylate, cyclohexyl methacrylate, n-decyl acrylate, n-decyl methacrylate, diethylene glycol diacrylate, diethylene glycol dimethacrylate, dipentaerythritol monohydroxypentaacrylate, 2-ethyoxyethoxyethyl acrylate, 2-ethoxyethyl methacrylate, ethoxylated bisphenol A diacrylate, ethoxylated bisphenol A dimethacrylate, ethoxylated trimethylolpropane triacrylate, ethyl methacrylate, ethylene glycol dimethacrylate, 2-ethylhexyl acrylate, 2-ethylhexyl methacrylate, furfuryl methacrylate, glyceryl propoxy triacrylate, 1,6hexanediol diacrylate, 1,6hexanediol dimethacrylate, n-hexyl acrylate, n-hexyl methacrylate, 4-hydroxybutyl-acrylate, butanediol monoacrylate, 2-hydroxyethyl acrylate, hydroxyethyl methacrylate, hydroxypropyl acrylate, hydroxypropyl methacrylate, isobomyl acrylate, isobomyl methacrylate, isobutyl acrylate, isobutyl methacrylate, isobutyl vinyl ether, isodecyl acrylate, isodecyl methacrylate, isooctyl acrylate, isopropyl methacrylate, lauryl acrylate, lauryl methacrylate, maleic anhydride, methacrylic anhydride, 2-methoxyethyl acrylate, methyl methacrylate, neopentyl acrylate, neopentyl methacrylate, neopentyl glycol diacrylate, neopentyl glycol dimethacrylate, n-octadecyl acrylate, stearyl acrylate, n-octadecyl methacrylate, stearyl methacrylate, n-octyl acrylate, pentaerythritol tetraacrylate, pentaerythritol triacrylate, 2-phenoxyethyl acrylate, 2-phenoxyethyl methacrylate, 2-phenylethyl methacrylate, phenyl methacrylate, polybutadiene diacrylate oligomer, polyethylene glycol 200 diacrylate, polyethylene glycol 400 diacrylate, polyethylene glycol 200 dimethacrylate, polyethylene glycol 400 dimethacrylate, polyethylene glycol 600 dimethacrylate, polypropylene glycol monomethacrylate, propoxylated neopentyl glycol diacrylate, stearyl acrylate, stearyl methacrylate, 2-sulfoethyl methacrylate, tetraethylene glycol diacrylate, tetraethylene glycol dimethacrylate, tetrahydrofurfuryl acrylate, tetrahydrofurfuryl methacrylate, n-tridecyl methacrylate, triethylene glycol diacrylate, triethylene glycol dimethacrylate, trimethylolpropane triacrylate, trimethylolpropane trimethacrylate, 3-methacryloxypropyltrimethoxysilane, trimethylsilylmethacrylate, (trimethylsilymethyl)methacrylate, tripropylene glycol diacrylate, tris(2-hydroxyethyl)isoyanurate triacrylate, vinyl acetate, vinyl caprolactam, n-vinyl-2-pyrrolidone, zinc diacrylate and zinc dimethacrylate.

9. The kit of claim 1, wherein the thermoset polymeric resin is mainly composed of Bisphenol-A-glycidyldimethacrylate (BisGMA) and triethylene glycol dimethacrylate (TEGDMA), with a weight ratio of BisGMA to TEGDMA from 9:1 to 1:9.

10. The kit of claim 1, wherein the initiator is at least one element selected from the group consisting of benzoyl peroxide, dicumyl peroxide, ethyl 4-dimethylaminobenzoate, and camphorquinone.

11. The kit of claim 10, wherein the initiator is present in amounts from about 0.2 wt % to about 5 wt % relative to the resin.

12. The kit of claim 1, wherein the at least one package includes a substantially airtight and substantially opaque bottle containing the resin and a substantially airtight and substantially opaque bag containing the initiator, the kit further comprising a bag containing the porous block.

13. The kit of claim 1, wherein the porous block is shaped by a rapid prototyping machine which cuts the block according to a digital scan of at least a portion of a patient's jaw.

14. The kit of claim 13, wherein the digital scan of at least a portion of a patient's jaw is obtained by using a digital dental system.

15. The kit of claim 14, wherein the porous block is cut according to the digital scan for thereafter being infiltrated with the resin mixture and polymerized.

16. The kit of claim 14, wherein the resin mixture is added to the porous block and polymerized which is thereafter cut by a rapid prototyping machine according to the digital scan.

17. The kit of claim 1, wherein the porous block is a ceramic.

18. The kit of claim 17, wherein the porous ceramic block is at least one element selected from the group consisting of alumina, zirconia, hydroxyapatite, and layered ceramic fabrics.

19. A kit to make a dental prosthetic device, comprising:
a porous block having pores and being shaped to match at least a portion of a patient's jaw as taken by a digital scan; and
a thermoset polymeric resin combined with an initiator to form a resin mixture to infiltrate the pores of the porous block;
wherein the resin mixture and the porous block are configured to be prepared and assembled into a dental device at a site of a dental procedure.

20. A kit to make a dental prosthetic device, comprising:
a porous block with pores; and
a thermoset polymeric resin and an initiator combined to form a resin mixture to infiltrate pores of the porous block;
wherein a digital scan of at least a portion of a patient's jaw is obtained for cutting the porous block thereto.
